(19) United States
(12) Patent Application Publication
(10) Pub. No.: US 2004/0016335 A1
(43) Pub. Date: Jan. 29, 2004

(54) Device for notching the spine of a book block formed with compressed signatures

(75) Inventor: Horst Knoetig, Farmingville, NY (US)

Correspondence Address: VENABLE, BAETJER, HOWARD AND CIVILETTI, LLP, P.O. BOX 34385, WASHINGTON, DC, 20043-9998, US

(73) Assignee: Muller Martini Holding AG, Hergiswil (CH)

(21) Appl. No.: 10/621,466

(22) Filed: Jul. 18, 2003

(30) Foreign Application Priority Data
Jul. 19, 2002 (EP) 02405627.7

(51) Int. Cl. B26D 1/12

(52) U.S. Cl. 83/671; 83/917

(57) ABSTRACT

For the notching of a book block spine, formed with compressed signatures, a notching tool is provided that rotates around a pivoting axis, approximately perpendicular to the book block spine, and which comprises cutting teeth for cutting into the book block spine while the book block is passing by along the conveying path for a perfect binder. The cutting teeth are attached to a disc-shaped carrier on the notching tool, so as to protrude on the front. The carrier of the notching tool is provided with at least two opposite-arranged cutting teeth, which are oriented at an acute angle to a circular cutting plane.

### BACKGROUND OF THE INVENTION

1. Field of the Invention

The invention relates to a device for notching the spine of a book block, formed with compressed signatures, with the aid of a notching tool that rotates around a pivot, positioned approximately perpendicular to the book block spine.

2. Related Art

With the perfect binding method, the mechanical processing of a book block spine is just as important as the glue application for ensuring its durability. The processing of the book block spine is intended to increase the surface area available for spreading the glue.

Coated papers or papers suitable for art printing make the perfect binding of a book block spine more difficult because of unsuitable characteristics.

For this reason and others, improvements in the binding method are desired. A known improvement is achieved through optimizing the structure of the book block spine by increasing the surface of the book block spine for the glue application, thus improving the rigidity through a favorable clamping effect.

U.S. Pat. No. 4,741,236 pursues this goal, among other things, with a device for notching the spine of a book block. The device includes a conveyor for moving a book block along a conveying path, wherein the spine of the book block projects for the processing. Positioned opposite the book block spine is a notching device with a cutting blade that is inclined the conveying direction of the book block and is driven around a vertical pivot. This pivot is hollow and has a shaft positioned on the inside, concentrically thereto, which extends past the blade on one end in order to drive a notching tool. The notching tool includes three side-by-side arranged cutting or milling blades for cutting notches or grooves of different depths in the spine while the book block passes by, wherein the notches extend transversely to the conveying direction and perpendicularly to the inclined blade. That is to say, with each rotation of the blade, three notches are produced that extend to different depths in the spine of the book block. The notches, which are positioned at an angle, allow the glue to adhere better to the spine of a book block. However, the device used in this application is expensive to use and maintain.

### SUMMARY OF THE INVENTION

In contrast to the device disclosed in U.S. Pat. No. 4,741,236, it is an object of an exemplary embodiment of the present invention to provide a device for notching the spine of a book block formed with compressed signatures which improves the adherence of the glue to the spine of a book block, as well as the clamping effect of the book block spine.

This object is solved according to the invention in that the carrier for the notching tool is provided with at least two cutting teeth, arranged opposite each other relative to a pivoting axis, and which are positioned at an acute angle to a circular cutting plane. As a result, a notching pattern structure can be realized in the book block spine, which noticeably improves the rigidity and clamping effect of a book block spine.

At least one of the cutting teeth is advantageously positioned at an angle to the center of the cutting circle for the notching tool, which results in alternately opposite inclined notches during the processing.

The same notching pattern can be generated if at least one of the cutting teeth is positioned so as to be inclined radially outward from the cutting circle center.

The notching tool carrier can be driven around a pivot, arranged perpendicularly to the conveying path. Thus, the book block spine is cut, if possible simultaneously, by respectively two spaced-apart, oppositely arranged cutting teeth.

Each cutting tooth cuts two notches with each rotation of the notching tool and/or the carrier.

Or, if the carrier for the notching tool is driven around a pivot that is inclined relative to the conveying path, the book block spine can be notched starting with a front end as seen in conveying direction. In the process, notches with a uniform orientation are generated on the book block spine if the cutting teeth on the carrier point in opposite directions, while notches pointing in opposite directions are generated on the book block spine if the cutting teeth point in the same direction.

The spacing and the pattern of the notches along the book block spine can be determined by adjusting the speed of the notching tool or the conveying speed of the book blocks along the conveying path for the perfect binder.

In an exemplary embodiment, the present invention can be a device for notching a book block spine formed with compressed signatures, the book block passing by the device along a conveying path for a perfect binder, the device comprising: a notching tool that rotates around a pivot, positioned approximately perpendicularly to the book block spine, the notching tool comprising: a carrier, defining a circular cutting plane; and at least two cutting teeth attached to and projecting from the front of the carrier, wherein the cutting teeth are positioned opposite each other relative to the pivot and are oriented at an acute angle β to the circular cutting plane, the teeth cutting into the book block spine to produce arc-shaped notches.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts a view from the side of an exemplary embodiment of the device according to the invention;

FIG. 2 depicts a basic outline of the device according to FIG. 1;

FIG. 3 depicts an exemplary notching pattern on a book block spine, following the processing with a device according to FIGS. 1 and 2;

FIG. 4 depicts a view from the side of an alternative exemplary embodiment of the device according to the invention;

FIG. 5 depicts a basic diagram of the device according to FIG. 4;

FIG. 6a depicts a view showing a section of a notching pattern on a book block spine, following the processing with a device according to FIGS. 4 and 5;

FIG. 6b depicts a view showing a section of an alternative notching pattern on a book block spine, following the processing with a device according to FIGS. 4 and 5; and

FIG. 7 depicts an enlarged representation of a cutting tooth according to the invention.

### DETAILED DESCRIPTION OF AN EXEMPLARY EMBODIMENT OF THE PRESENT INVENTION

A preferred embodiment of the invention is discussed in detail below. While specific exemplary embodiments are discussed, it should be understood that this is done for illustration purposes only. A person skilled in the relevant art will recognize that other components and configurations can be used without parting from the spirit and scope of the invention.

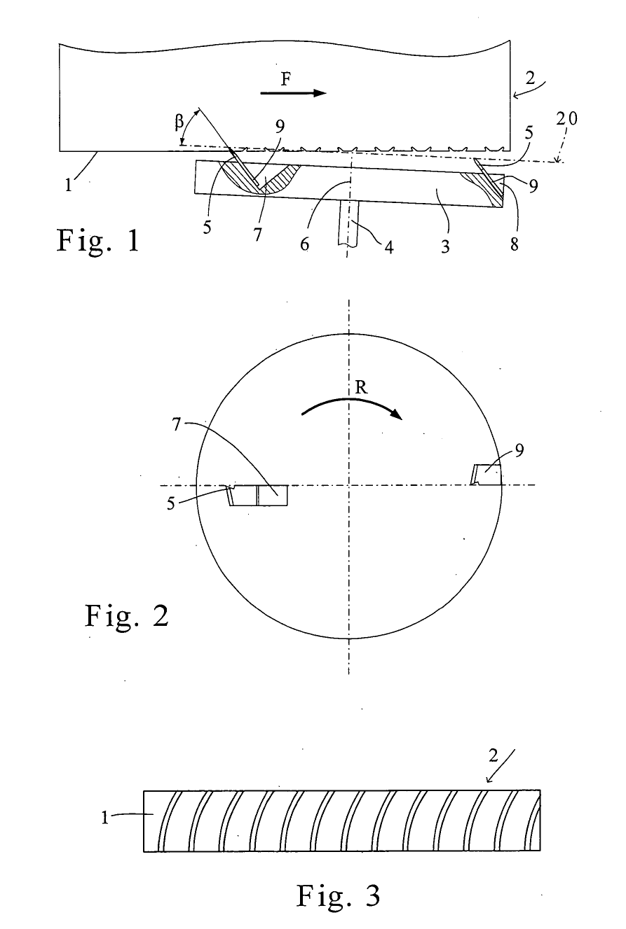

FIGS. 1 and 2 show a device for notching a book block spine 1 of a book block 2 (partially visible), formed with signatures that are compressed at least along the side flanges. The upright standing block 2 is transported in the direction F along the conveying path for a perfect binder, with the book block spine 1 facing the notching device. Prior to that, the folded edges of the individual signatures forming the block 2 were machined off while the book block, held in the clamp of a perfect binder, was moved past a milling station. Thus, the book block spine 1 has a mostly level surface for the subsequent notching operation.

The device shown in FIGS. 1 and 2 for notching the book block spine 1 includes a preferably disc-shaped carrier 3 that is connected to a drive shaft 4 and is provided with two cutting teeth 5 facing the book block spine 1. The cutting teeth are mounted on opposite sides of the pivot 6, so as to project on the carrier 3, as illustrated in the embodiment shown herein. The cutting teeth 5, which project with the same inclination from the carrier 3, generate a notching pattern as shown in FIG. 3. That is, a pair of notches generated in the book block spine by the cutting teeth 5 will point in opposite directions. These indentations can have different lengths and more than two cutting teeth 5 could conceivably be attached to the carrier 3. The spacing between the notches depends on the conveying speed for the book blocks and the rotational speed of the cutting teeth 5. In FIG. 2, the rotational direction of these teeth is indicated with the arrow R. The carrier 3, which has a circular design to avoid irregular rotational forces, is slightly inclined relative to the spine 1 of the book block 2, which passes by. Thus, only one tooth 5 in each instance cuts at the same location across the width into the book block spine 1, wherein the cutting distance at least equals the book block thickness and results in a notch shaped like a circular arc. The cutting teeth 5 are installed with the aid of a shaft 9 in the recesses 7, 8 of carrier 3, preferably so as to be replaceable, and form an acute angle β relative to the cutting plane 20 formed by these teeth. The recesses 7, 8 are triangular in the cross section and their width approximately matches the width of a shaft 9 for a cutting tooth 5, as defined for a side holder. The cutting teeth 5 can be soldered or screwed to their shaft 9 on the carrier 3.

FIG. 3 provides an image of the notching pattern produced on a book block spine with the device according to FIGS. 1 and 2, wherein the notched sections clearly show that the edge of the book block spine 1 is located approximately in the plane for the pivot 6 of the notching tool during the notching operation.

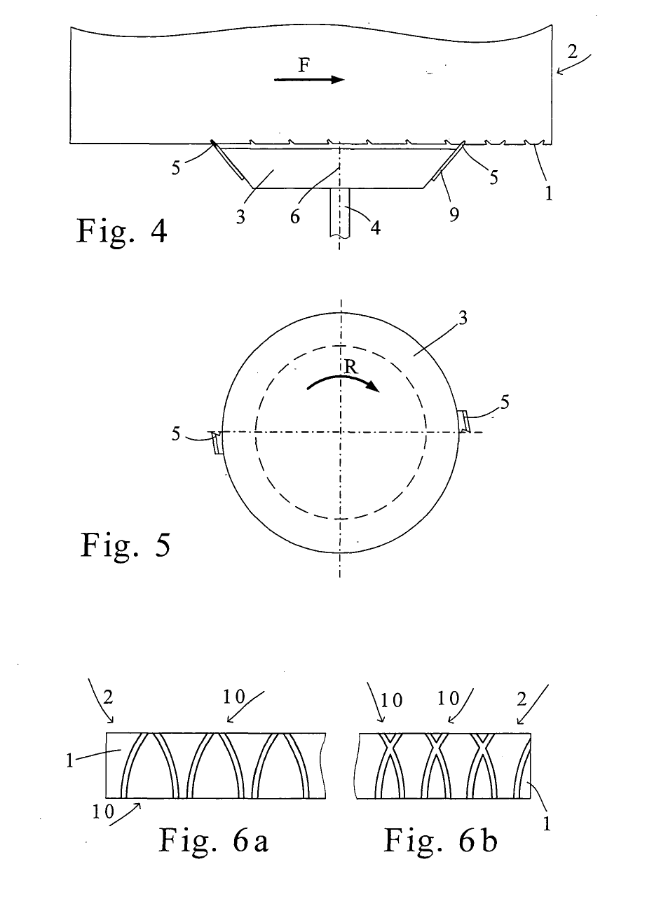

FIGS. 4 to 6b show an alternative embodiment of the notching tool and the notching pattern. According to FIG. 4, the cutting teeth 5 are attached along the circumference of a disc-shaped carrier 3 with the cross-sectional shape of a truncated cone. The cutting teeth 5 are attached permanently or so as to be replaceable along a surface line of the carrier 3 and are the same cutting teeth 5 that were previously shown in FIGS. 1 and 2. The cutting teeth 5 could also be mounted inside recesses.

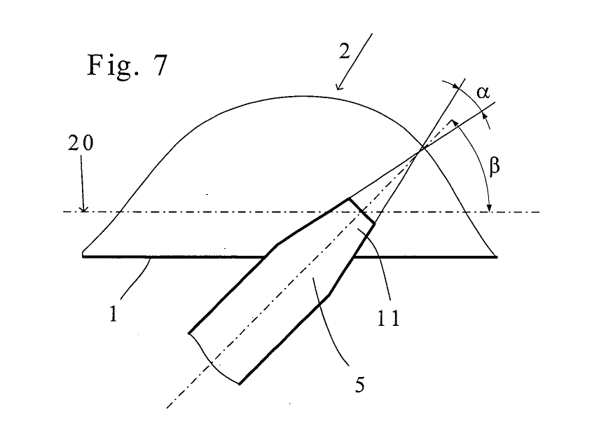

Another difference to FIGS. 1 and 2 is that the pivot 6 and/or the drive shaft 4 that is connected to the carrier 3 is oriented approximately perpendicularly to the conveying path and/or to the book block spine 1. Thus, both cutting teeth 5 that are positioned opposite each other relative to the pivot 6 respectively cut notches into the book block spine 1. Both cutting teeth 5 participate equally in producing the pairs 10 of notched sections that mirror each other (see also FIGS. 6a and 6b), the arrangement of which is shown in FIG. 4. As shown in FIG. 3, the notching pattern according to FIGS. 6a and 6b is also not arranged symmetrically to the longitudinal axis of the book block spine 1.

FIG. 7 shows segments of the cross-sectional geometry in the cutting region of a cutting tooth 5, e.g. as used for the embodiment according to FIG. 4. The cutting tip 11 has a wedge-shaped, cross-sectional form with angle α, so that the shavings can be removed from the book block spine 1 without problems. Otherwise, the cutting geometry of the cutting tooth 5 resembles that of a chisel.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A device for notching a book block spine formed with compressed signatures, the book block passing by the device along a conveying path for a perfect binder, the device comprising:
a notching tool that rotates around a pivot, positioned approximately perpendicularly to the book block spine, the notching tool comprising:
a carrier, defining a circular cutting plane; and
at least two cutting teeth attached to and projecting from the front of the carrier, wherein the cutting teeth are positioned on opposite sides of the carrier relative to the pivot and are oriented at an acute angle β to the circular cutting plane, the teeth cutting into the book block spine to produce arc-shaped notches.

2. The device according to claim 1, wherein at least one of the cutting teeth is positioned so as to point radially inward to a center of the carrier.

3. The device according to claim 1, wherein at least one of the cutting teeth is positioned so as to point radially outward from the center of the carrier.

4. The device according to claim 1, wherein the carrier for the notching tool is driven around a pivot that is arranged perpendicularly to the conveying path.

5. The device according to claim 1, wherein the carrier for the notching tool is driven around a pivot that is arranged at an angle to the conveying path.

6. The device according to claim 1, wherein the carrier comprises recesses inside which the cutting teeth are mounted.

7. The device according to claim 1, wherein the carrier has a truncated cone shape and the cutting teeth are attached along a surface line of the truncated cone.

8. The device according to claim 1, wherein the cutting teeth are attached to the carrier such that the teeth project with different lengths.

9. The device according to claim 1, wherein the carrier is disc-shaped.
